(19) United States
(12) Patent Application Publication
(10) Pub. No.: US 2002/0105644 A1
(43) Pub. Date: Aug. 8, 2002

(54) Apparatus and methods to compensate for polarization-dependent losses

(76) Inventor: Timothy J. Britton, Dexter, MI (US)

Correspondence Address: John G. Posa, Gifford, Krass, Groh, Sprinkle,, Anderson & Citkowski, PC, 280 N. Old Woodward Ave., Suite 400, Birmingham, MI, 48009, US

(21) Appl. No.: 10/068,129

(22) Filed: Feb. 5, 2002

Related U.S. Application Data
(60) Provisional application No. 60/266,840, filed on Feb. 6, 2001.

(51) Int. Cl. G01J 3/02

(52) U.S. Cl. 356/328; 356/327

(57) ABSTRACT

Polarization-dependent losses (PDL) are balanced in an optical system through the use of a weak polarizer placed in an optical path so as to compensate for the static PDL of the rest of the system. The weak polarizer comprises an interface or a layer of material having a different refractive index in the operating wavelength band, placed in the optical path at an angle to provide a desired level of PDL compensation. The geometry and indices of the two material are deliberately chosen to compensate for PDL elsewhere in the system. One implementation of the invention involves the use glass and air as the two materials, either in the form of a prism or a glass plate. The invention may alternatively take the form of a weak polarizer adhered to, or sandwiched between, a block of optical material such as glass. Preferably, a material having an index close to that of glass would be used in such a case, such as a polymer. The invention is applicable to many different optical configurations, including spectrum analysis, optical telecommunication networks and multiplexing devices. A Raman/fluorescence detection system is disclosed including a grating which diffracts and spectrally disperses light at characteristic wavelengths. In this embodiment, the PDL compensator is preferably placed in the optical path upstream of the grating (whether reflective or transmissive), with a trap being used to collect energy of the unwanted polarization.

### REFERENCE TO RELATED APPLICATION

This application claims priority from U.S. provisional patent application Serial No. 60/266,840, filed Feb. 6, 2001, the entire contents of which are incorporated herein by reference.

### FIELD OF THE INVENTION

There are many optical systems wherein it is important to balance the ratio of Sand P-polarized light. Such applications include spectrum analysis, optical telecommunication networks and multiplexing devices.

As one example, U.S. Pat. No. 6,310,720 describes an optical amplifier module that is insensitive to polarization comprising a first fiber, a second fiber, a semiconductor optical amplifier (SOA), and a polarization dependent loss (PDL) unit. The PDL unit provides a polarization dependent loss that matches the polarization dependent gain in the SOA. In the simplest embodiment, the PDL unit is a polarizing fiber of a predetermined length. A second embodiment uses a polarizer and lenses for optical coupling. The polarizer is preferably a parallel-metallic-strip polarizer which is modified to provide only a minimal or needed amount of rejection. This is accomplished by increasing the distance between metallic strips, or by shortening the length of the metallic strips and introducing gaps of a predetermined length.

The third embodiment of the PDL unit uses first and second fibers which are butt coupled and offset by a predetermined amount. By creating a shift between the two butt-coupled fibers, an asymmetry can be introduced, thereby providing the different polarizations with different boundary conditions, and thus polarization dependent loss. The fourth embodiment for the PDL unit preferably comprises a fiber, a rod, and a means for applying pressure. By adjusting the degree to which the fiber is bent by the rod, the polarization dependent loss is introduced and adjusted to match the polarization dependent gain of the SOA.

In a fifth embodiment, the PDL unit takes the form of a coating added to the SOA chip. According to a final embodiment, the polarization dependent loss provided by the fiber is adjusted based on the asymmetries introduced by the orientation of the fiber relative to the SOA. In particular, by adjusting x, y, z, or angle of the fiber relative to the SOA, the asymmetry of the spreading angles between the TE and TM modes can be used to adjust the relative polarization dependent TE/TM coupling loss so that it matches the SOA. The '720 patent also discloses variable PDL unit, including units having a tunable loss

In addition to the approaches just described, systems do exist which separate a beam of light on the basis of polarization, and separately amplify one or both of the components. However, such solutions are expensive, particularly in systems where it is not the intensity of the optical energy which is important, but rather the balance between S and P.

### SUMMARY OF THE INVENTION

This invention adjusts for polarization-dependent losses (PDL) in an optical system through the use of a weak polarizer placed in an optical path so as to compensate for the static PDL of the rest of the system. The invention is applicable to many different optical configurations, including spectrum analysis, optical telecommunication networks and multiplexing devices.

The weak polarizer comprises an interface or a layer of material having a different refractive index in the operating wavelength band, placed in the optical path at an angle to provide a desired level of PDL compensation. The geometry and indices of the two materials are deliberately chosen to compensate for PDL elsewhere in the system.

One implementation of the invention involves the use glass and air as the two materials, either in the form of a prism or a glass plate. The invention may alternatively take the form of a weak polarizer adhered to, or sandwiched between, a block of optical material such as glass. Preferably, a material having an index close to that of glass would be used in such a case, such as a polymer.

A Raman/fluorescence detection system is disclosed including a grating which diffracts and spectrally disperses light at characteristic wavelengths. In this embodiment, the PDL compensator is preferably placed in the optical path upstream of the grating (whether reflective or transmissive), with a trap being used to collect energy of the unwanted polarization.

### BRIEF DESCRIPTION OF THE DRAWINGS

FIGS. 1A and 1B are drawing which illustrate the way in which a weak polarizing affect may be dictated by the index difference at the planar interface of the two materials such as glass and air, either in the form of a prism (FIG. 1A) or a glass plate (FIG. 1B);

FIG. 2 shows an alternative embodiment of the invention wherein a weak polarizer such as a polymer is adhered to, or sandwiched between, a block of optical material such as glass; and

FIG. 3 is a diagram which shows the way in which a polarization compensator according to the invention would be used in a system, in this case a spectrometer.

### DETAILED DESCRIPTION OF THE INVENTION

Broadly, this invention adjusts for polarization-dependent losses (PDL) in an optical system through the use of a weak polarizer placed in an optical path so as to compensate for the static PDL of the rest of the system. In the preferred embodiment, the weak polarizer is constructed of two materials having a different refractive index in the operating wavelength band, placed in the optical path at an angle to provide a desired level of PDL compensation.

In the preferred embodiment, the index between the two materials exhibits a weak polarizing effect dictated by the index difference at the planar interface of the two materials. The geometry and indices of the two material are deliberately chosen to compensate for PDL elsewhere in the system.

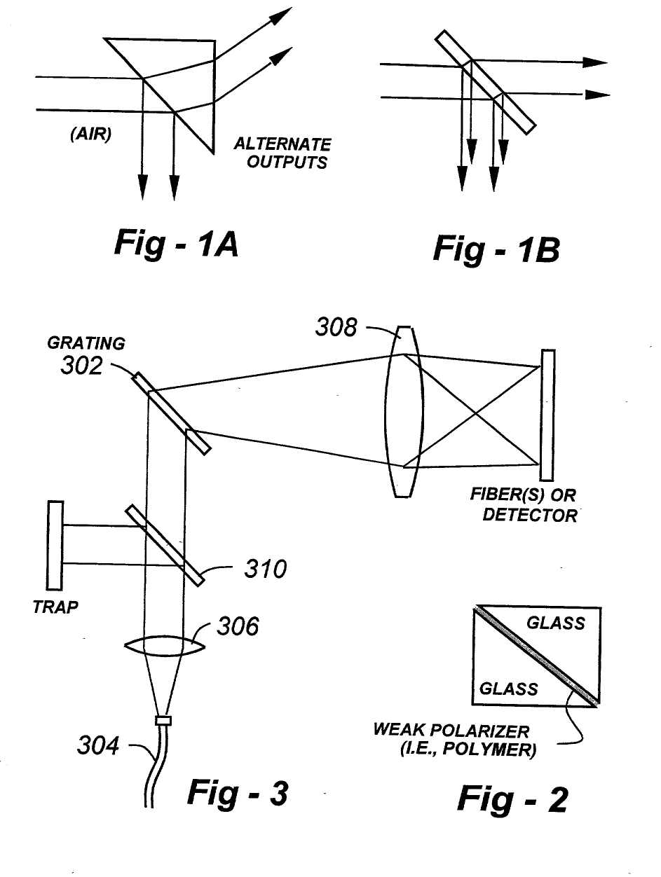

As shown in FIG. 1, the simplest case involves the use glass and air as the two materials, either in the form of a prism (FIG. 1A) or a glass plate (FIG. 1B). Due to the different reflectivity at the angled interface between the S and P polarized input, the straight-through output will have a P-polarized bias, and the reflected output will have an S-polarized bias.

As shown in FIG. 2, the invention may alternatively take the form of a weak polarizer adhered to, or sandwiched between, a block of optical material such as glass. Preferably, a material having an index close to that of glass would be used in such a case, such as a polymer.

FIG. 3 shows the way in which the compensator would be used in a Raman (or fluorescence) detection system. The system includes a grating 302 which may be supported between two right-angle prisms (not shown). Light under investigation arriving or via fiber 304 illuminates one surface of the grating 302 after passing through collimating lens 306.

The grating 302 diffracts and spectrally disperses light at characteristic wavelengths, which are focused by lens 308 onto another set of fibers or a photodetector or analysis purposes. According to the invention, compensator 310 is preferably be placed in the optical path upstream of the grating (whether reflective or transmissive), with a trap 312 being used to collect energy of the unwanted polarization. Although the orientation of compensator 310 in FIG. 3 is shown to correct for an S-polarization gain, it will be apparent to one of skill that the compensator (and trap) may be rotated 90 degrees about the optical axis to compensate for P-type polarization.

I claim:

1. In a system having an optical path exhibiting polarization-dependent losses (PDL), apparatus for balancing the PDL, comprising:
a surface in the optical path forming part of a weak polarizer,
the polarizer being operative to separate out a level of polarization adjusted to compensate for the PDL.

2. The apparatus of claim 1, wherein the surface forms part of an air-glass interface.

3. The apparatus of claim 2, wherein the air-glass interface is provided by a prism or glass plate.

4. The apparatus of claim 1, wherein surface forms part of a layer of material having an index close to that of glass.

5. The apparatus of claim 1, wherein the material is a polymer.

6. The apparatus of claim 1, wherein the optical path forms part of a spectroscopic system.

7. The apparatus of claim 2, wherein the spectroscopic system includes a dispersive grating disposed in the optical path, and the polarizer is in the path before the grating.

8. In a spectroscopic system including a dispersive grating an optical path exhibiting polarization-dependent losses (PDL), apparatus for balancing the PDL, comprising:
a surface in the optical path forming part of a weak polarizer,
the polarizer being operative to separate out a level of polarization adjusted to compensate for the PDL.

9. The apparatus of claim 8, wherein the surface forms part of an air-glass interface.

10. The apparatus of claim 9, wherein the air-glass interface is provided by a prism or glass plate.

11. The apparatus of claim 8, wherein surface forms part of a layer of material having an index close to that of glass.

12. The apparatus of claim 8, wherein the material is a polymer.

13. The apparatus of claim 8, wherein the polarizer is supported in the path before the grating.

14. Apparatus for balancing polarization-dependent losses (PDL) in a spectroscopic system comprising:
a dispersive grating supported in an optical path; and
a surface in the optical path forming part of a weak polarizer,
the polarizer being operative to separate out a level of polarization adjusted to compensate for the PDL.

15. The apparatus of claim 14, wherein the surface forms part of an air-glass interface.

16. The apparatus of claim 15, wherein the air-glass interface is provided by a prism or glass plate.

17. The apparatus of claim 14, wherein surface forms part of a layer of material having an index close to that of glass.

18. The apparatus of claim 17, wherein the material is a polymer.

19. The apparatus of claim 14, wherein the polarizer is supported in the path before the grating.
